(19) United States
(12) Patent Application Publication
(10) Pub. No.: US 2026/0281046 A1
(43) Pub. Date: Sep. 17, 2026

(54) COMMUNICATION METHOD AND RELATED APPARATUS

(71) Applicant: HUAWEI TECHNOLOGIES CO., LTD., Shenzhen (CN)

(72) Inventors: Shaoyun Wu, Shanghai (CN); Qi Yao, Dongguan (CN); Weijun Xing, Shanghai (CN)

(73) Assignee: HUAWEI TECHNOLOGIES CO., LTD., Shenzhen (CN)

(21) Appl. No.: 19/672,085

(22) Filed: May 8, 2026

Related U.S. Application Data
(63) Continuation of application No. PCT/CN2024/130439, filed on Nov. 7, 2024.

(30) Foreign Application Priority Data
Nov. 10, 2023 (CN) 202311503479.6

(51) Int. Cl. H04L 47/2483

(52) U.S. Cl. CPC H04L 47/2483

(57) ABSTRACT

The present disclosure relates to communication methods and devices. One example method includes receiving a service flow identification model of a target service, receiving service data from a terminal, identifying, from the service data based on the service flow identification model, first service data of the target service and/or second service data of a non-target service, and forwarding the first service data to a first processing network element, and/or forwarding the second service data to an anchor network element. The first processing network element is configured to process the first service data based on a function image of the target service, and the anchor network element is configured to forward the second service data to an application server of the second service data, or is configured to process the second service data.

### CROSS-REFERENCE TO RELATED APPLICATIONS

This application is a continuation of International Application No. PCT/CN 2024/130439, filed on Nov. 7, 2024, which claims priority to Chinese Patent Application No. 202311503479.6, filed on Nov. 10, 2023. The disclosures of the aforementioned applications are hereby incorporated by reference in their entireties.

### TECHNICAL FIELD

Embodiments of this application relate to the communication field, and in particular, to a communication method and a related apparatus.

### BACKGROUND

An application provider may provide application services for terminals through a server, a cloud server, or the like.

Some application services have high requirements in terms of delay, bandwidth, or other aspects of service quality. To meet these requirements, the application provider may deploy servers on edge computing (MEC) nodes or edge clouds (ECs), through which application services are provided for terminals. These MEC nodes or ECs may belong to the application provider itself or a telecom operator.

The MEC/EC deployment locations are usually fixed, whereas terminals are movable. If a terminal moves out of the service range of an MEC/EC, the distance between the terminal and the MEC/EC increases, and the resulting delay may no longer meet the service quality requirements of the application, thereby affecting user experience. Furthermore, if the application provider deploys the MEC/EC on its own, it not only needs to purchase computing and storage resources, but also needs to lease dedicated lines from telecom operators, resulting in high costs.

### SUMMARY

Embodiments of this application provide a communication method and a related apparatus to reduce the difficulty and cost for an application provider to offer application services to users.

According to a first aspect, an embodiment of this application provides a communication method. The method is applied to a first forwarding network element, and the method includes: The first forwarding network element receives a service flow identification model of a target service. The first forwarding network element receives service data from a terminal, and identifies, from the service data based on the service flow identification model, first service data of the target service and/or second service data of a non-target service. After the service data is identified, the first forwarding network element forwards the first service data to a first processing network element, and/or forwards the second service data to an anchor network element. The first processing network element is configured to process the first service data based on a function image of the target service, and the anchor network element is configured to forward the second service data to an application server of the second service data, or is configured to process the second service data.

In embodiments of this application, the first forwarding network element, the first processing network element, and the anchor network element may be a UPF, a RAN, or another widely distributed network element in a network. The anchor network element may be a local central network element in an area in which the terminal is located, for example, a local central UPF. A distance between the anchor network element and the terminal is greater than a distance between the first processing network element and the terminal.

In embodiments of this application, the first forwarding network element on which the service flow identification model is deployed is used to offload the service data from the terminal. The first service data that has a high service quality requirement in the service data is forwarded to a closer first processing network element for processing, and the second service data that has a low service quality requirement in the service data is forwarded to a farther application server through the anchor network element for processing (or locally processed by the anchor network element), thereby implementing traffic offloading. In comparison with the application server deployed on the anchor network element or a central cloud/Internet, the first processing network element has a shorter communication distance with the terminal, and processes a small amount of data (the application processor needs to process service data in various places, and the first processing network element only needs to cover service data within a service range). Therefore, the first processing network element can provide a high quality application service for the terminal, thereby ensuring service quality of the application service.

In addition, because a network has a wide coverage, as long as the terminal is within the coverage of the network, functions of the first forwarding network element and the first processing network element can be implemented by using a network element device deployed in the network. The target service can be processed nearby by using a current network resource, and there is no need to additionally purchase computing, storage, communication, and other resources to process the data of the target service, so that costs can be reduced.

In an optional implementation, before the first forwarding network element receives the service data from the terminal, the first forwarding network element receives the first transmission channel information. The first transmission channel information indicates the first forwarding network element to forward the first service data to the first processing network element through a first transmission channel.

In embodiments of this application, the first transmission channel information between the first forwarding network element and the first processing network element may be allocated by the first network element (for example, a session management function), or may be allocated by the first processing network element. The first transmission channel may be a tunnel, and may traverse an underlying IP transport network, to ensure data security and transmission reliability.

In an optional implementation, before the first forwarding network element receives the service data from the terminal, the first forwarding network element sends the second transmission channel information. The second transmission channel information indicates the first processing network element to forward third service data of the target service to the first forwarding network element through a second transmission channel.

In embodiments of this application, the second transmission channel information between the first processing network element and the first forwarding network element may be allocated by the first network element (for example, an SMF), or may be allocated by the first forwarding network element. The second transmission channel may be a tunnel, and may traverse an underlying IP transport network, to ensure data security and transmission reliability. The second transmission channel information may be tunnel information, and the tunnel information may correspond to the terminal. Therefore, after receiving the third service data, the first forwarding network element may transmit the third service data to the terminal corresponding to the tunnel information, so that the third service data is transmitted from the first processing network element to the terminal.

According to a second aspect, an embodiment of this application provides a communication method. The method is applied to a first network element, and the method includes: The first network element receives a service request, where the service request includes an identifier of a target application and a first location identifier of a terminal. The first network element determines a first forwarding network element and a first processing network element based on the first location identifier. The first forwarding network element is configured to: identify first service data from service data from the terminal based on a service flow identification model, and forward the first service data to the first processing network element, where the first service data is service data of a target service in the target application. The first processing network element is configured to process the first service data based on a function image of the target service. Then, the first network element establishes a transmission channel among the terminal, the first forwarding network element, and the first processing network element.

In embodiments of this application, the first network element determines, based on a location of the terminal, the first forwarding network element used to deploy the service flow identification model and the first processing network element used to deploy the function image. In one aspect, a network element (for example, an access network node or a user plane function) has been widely deployed in a mobile communication network, to provide ubiquitous services for the terminal. As long as the terminal moves within a coverage of the mobile communication network, the first network element can determine the first forwarding network element and the first processing network element (determine the first forwarding network element and the first processing network element from a large quantity of widely covered network elements) for the terminal, and provide an application service with high service quality for the terminal by using the first forwarding network element and the first processing network element. According to the communication method provided in embodiments of this application, an area with high service quality of the target service can be expanded, and a high quality service can be basically implemented within coverage of a mobile network.

In addition, an operator or service provider does not need to purchase computing and storage resources again, and does not need to establish a network pipe. This can reduce costs of the service provider, expand the pipe of the network operator, and help the operator monetize resources.

In addition, in the mobile communication network, service ranges of different network elements (for example, the first forwarding network element and the first processing network element) are divided at a finer granularity, thereby shortening a distance between the terminal and a data processing location (originally, the distance is from the terminal to the application server, and in embodiments of this application, the distance is only from the terminal to the first processing network element). The service ranges are divided at the fine granularity (for example, by street or by cell), so that a communication distance between the terminal and the first processing network element is short, thereby improving an upper limit of service quality of the target service by shortening the communication distance.

In an optional implementation, a step of determining, by the first network element, the first forwarding network element based on the first location identifier may specifically include: The first network element determines, based on the first location identifier, whether a second forwarding network element that covers a location of the terminal exists, where the second forwarding network element has loaded the service flow identification model. If such second forwarding network element exists, the first network element determines the second forwarding network element as the first forwarding network element; or if no such second forwarding network element exists, the first network element determines, based on the first location identifier, the first forwarding network element for loading the service flow identification model.

In embodiments of this application, the first network element determines, based on the first location identifier, whether the service flow identification model has been deployed near the terminal. If the service flow identification model has been deployed, the second forwarding network element on which the service flow identification model has been deployed is directly used to identify and offload the service data from the terminal (that is, the second forwarding network element is used as the first forwarding network element), and the service flow identification model does not need to be temporarily deployed. Therefore, deployment efficiency of the service flow identification model is high.

In an optional implementation, before the first network element receives the service request, the first network element obtains the service flow identification model, and sends the service flow identification model to the second forwarding network element.

In embodiments of this application, the first network element sends the service flow identification model to the second forwarding network element, to implement deployment of the service flow identification model on the second forwarding network element. The service flow identification model is deployed on the second forwarding network element before the first network element receives the service request, and deployment efficiency of the service flow identification model is high.

In an optional implementation, after the first network element determines, based on the first location identifier, the first forwarding network element for loading the service flow identification model, the first network element obtains the service flow identification model, and sends the service flow identification model to the first forwarding network element.

In an optional implementation, before the first network element sends the service flow identification model to the second forwarding network element, the first network element receives deployment information from the second network element, where the deployment information includes first deployment area information of the service flow identification model. Then, the first network element determines the second forwarding network element based on the first deployment area information.

In embodiments of this application, the second network element allocates the first deployment area information to the service flow identification model of the target service based on a requirement of the target service, and the first network element determines the second forwarding network element based on the first deployment area information. In this way, deployment of the service flow identification model can be implemented based on the requirement of the target service, thereby avoiding a waste of network resources. For example, the application provider may determine a hotspot area in which the target service is used, and the first network element deploys the service flow identification model within the first deployment area (an area indicated by the first deployment area information) corresponding to the hotspot area. This can avoid deploying the service flow identification model in advance in an area in which a probability of using the target service is low, thereby avoiding a waste of network resources caused by unnecessary deployment.

In an optional implementation, before the first network element sends the service flow identification model to the second forwarding network element, the first network element receives deployment request information from the application provider, where the deployment request information includes the service flow identification model. Then, the first network element determines the first deployment area information of the service flow identification model, and determines the second forwarding network element based on the first deployment area information.

In embodiments of this application, the first network element allocates the first deployment area information to the service flow identification model of the target service based on the requirement of the target service, and determines the second forwarding network element based on the first deployment area information. In this way, deployment of the service flow identification model can be implemented based on the requirement of the target service, thereby avoiding a waste of network resources. For example, the application provider may determine a hotspot area in which the target service is used, and the first network element deploys the service flow identification model within the first deployment area (an area indicated by the first deployment area information) corresponding to the hotspot area. This can avoid deploying the service flow identification model in advance in an area in which a probability of using the target service is low, thereby avoiding a waste of network resources caused by unnecessary deployment.

In an optional implementation, the deployment request information further includes first deployment requirement information of the service flow identification model. The step in which the first network element determines the first deployment area information of the service flow identification model may specifically include: The first network element determines the first deployment area information based on the first deployment requirement information.

In embodiments of this application, the first network element specifically determines the deployment area of the service flow identification model based on the requirement of the service flow identification model, so that the service flow identification model can be deployed in an area that better meets the requirement, thereby improving service data forwarding efficiency. For example, if the first deployment requirement information indicates that the service flow identification model is to be deployed on a first forwarding network element at a district level, the first network element may deploy the service flow identification model on one or more first forwarding network elements at the district level in the hotspot area.

In an optional implementation, the step in which the first network element determines the first processing network element based on the first location identifier may specifically include: The first network element determines, based on the first location identifier, whether a second processing network element that covers the location of the terminal exists, where the second processing network element has loaded the function image. If such second processing network element exists, the first network element determines the second processing network element as the first processing network element; or if no such second processing network element exists, the first network element determines, based on the first location identifier, the first processing network element for loading the function image.

In embodiments of this application, the first network element determines, based on the first location identifier, whether the function image has been deployed near the terminal. When the function image has been deployed, the second processing network element that has been deployed is directly used to process the first service data from the terminal (that is, the second processing network element is used as the first processing network element), and the function image does not need to be temporarily deployed. Therefore, deployment efficiency of the function image is high.

In an optional implementation, before the first network element receives the service request, the first network element obtains the function image, and sends the function image to the second processing network element.

In embodiments of this application, the first network element sends the function image to the second processing network element, to implement deployment of the function image on the second processing network element. The function image is deployed on the second processing network element before the first network element receives the service request, and deployment efficiency of the function image is high.

In an optional implementation, after the first network element determines, based on the first location identifier, the first processing network element for loading the function image, the first network element obtains the function image and sends the function image to the first processing network element.

In an optional implementation, before the first network element sends the function image to the second processing network element, the first network element receives the deployment information from the second network element, where the deployment information includes second deployment area information of the function image. Then, the first network element determines the second processing network element based on the second deployment area information.

In embodiments of this application, the second network element allocates the second deployment area information to the function image of the target service based on the requirement of the target service, and the first network element determines the second processing network element based on the second deployment area information. In this way, deployment of the service flow identification model can be implemented based on the requirement of the target service, thereby avoiding a waste of network resources. For example, the application provider may determine a hotspot area in which the target service is used, and the first network element deploys the function image in the second deployment area (an area indicated by the second deployment area information) corresponding to the hotspot area. This can avoid deploying the function image in advance in an area in which a probability of using the target service is low, thereby avoiding a waste of network resources caused by unnecessary deployment.

In an optional implementation, before the first network element determines the second processing network element for the function image, the first network element receives the deployment request information from the application provider, where the deployment request information includes the function image. Then, the first network element determines the second deployment area information of the function image, and determines the second processing network element based on the second deployment area information.

In embodiments of this application, the first network element allocates the second deployment area information to the function image of the target service based on the requirement of the target service, and determines the second processing network element based on the second deployment area information. In this way, deployment of the service flow identification model can be implemented based on the requirement of the target service, thereby avoiding a waste of network resources. For example, the application provider may determine a hotspot area in which the target service is used, and the first network element deploys the function image in the second deployment area (an area indicated by the second deployment area information) corresponding to the hotspot area. This can avoid deploying the function image in advance in an area in which a probability of using the target service is low, thereby avoiding a waste of network resources caused by unnecessary deployment.

In an optional implementation, the deployment request information further includes second deployment requirement information of the function image. The step in which the first network element determines the second deployment area information of the function image may specifically include: The first network element determines the second deployment area information based on the second deployment requirement information.

In embodiments of this application, the first network element specifically determines the deployment area of the function image based on the requirement of the function image, so that the function image can be deployed in an area that better meets the requirement, thereby improving processing efficiency of the first service data. For example, if the second deployment requirement information indicates that the service flow identification model is to be deployed on the first processing network element at a city level, the first network element may deploy the service flow identification model on one or more first processing network elements at the city level in the hotspot area.

In an optional implementation, the step in which the first network element receives the deployment request information from the application provider may specifically include: The first network element receives the deployment request information that has been verified from a third network element, where the third network element is configured to verify information from the application provider.

In embodiments of this application, the third network element (for example, an NEF) verifies the deployment request information, so that security of network exposure can be improved, and an attacker can be prevented from attacking the network by masquerading as the application provider, or the application provider can be notified in time when the network cannot meet the requirement of the request information.

In an optional implementation, before the first network element determines the first forwarding network element and the first processing network element based on the first location identifier, the first network element obtains third deployment requirement information of the target service, where the third deployment requirement information includes at least one of the following: service quality information and delay requirement information of the target service. The step in which the first network element determines the first forwarding network element and the first processing network element based on the first location identifier may specifically include: The first network element determines the first forwarding network element and the first processing network element based on the third deployment requirement information and the first location identifier.

In embodiments of this application, the first network element determines the first forwarding network element and the first processing network element based on the third deployment requirement information of the target service, so that the first forwarding network element and the first processing network element that are more suitable for the target service can be determined in a targeted manner. For example, if the third deployment requirement information includes a delay requirement of the target service, the first network element may determine, near the terminal, a network element with a smaller delay as the first forwarding network element and the first processing network element.

In an optional implementation, a distance between the first processing network element and the terminal is greater than a distance between the first forwarding network element and the terminal.

In embodiments of this application, compared with the first forwarding network element, the first processing network element may support a wider service coverage. Therefore, first service data of a plurality of first forwarding network elements may be forwarded to a same first processing network element for processing, thereby fully utilizing computing power of the first processing network element.

In an optional implementation, the first forwarding network element and the first processing network element are a same network element.

In an optional implementation, there are a plurality of first forwarding network elements.

According to a third aspect, an embodiment of this application provides a communication method. The method is applied to a second network element, and the method includes: The second network element receives deployment request information from an application provider, where the deployment request information includes a service flow identification model and/or a function image of a target service. The second network element determines, based on the deployment request information, first deployment area information of the service flow identification model and/or second deployment area information of the function image. Then, the second network element sends deployment information to the first network element, where the deployment information includes the first deployment area information and/or the second deployment area information.

In embodiments of this application, the application provider only needs to send one piece of deployment request information to the second network element, and include the service flow identification model and the function image of the target service in the deployment request information, so that an exposure capability of the mobile communication network can be used. The application provider deploys the function image on a network, and does not need to deploy an edge cloud by itself, thereby greatly reducing costs. In addition, the application provider has a low threshold for using a network exposure capability, and does not need to learn a complex network architecture and rule, thereby improving enthusiasm of the application provider for using the network exposure capability.

In an optional implementation, the deployment request information further includes first deployment requirement information of the service flow identification model and/or second deployment requirement information of the function image. The step in which the second network element determines, based on the deployment request information, the first deployment area information of the service flow identification model and/or the second deployment area information of the function image may specifically include: The second network element determines the first deployment area information based on the first deployment requirement information; and/or the second network element determines the second deployment area information based on the second deployment requirement information.

In embodiments of this application, the first network element specifically determines the deployment area of the service flow identification model based on the requirement of the service flow identification model, so that the service flow identification model can be deployed in an area that better meets the requirement, thereby improving service data forwarding efficiency. The first network element specifically determines the deployment area of the function image based on the requirement of the function image, so that the function image can be deployed in an area that better meets the requirement, thereby improving processing efficiency of the first service data. For example, if the first deployment requirement information indicates that the service flow identification model is to be deployed on the first forwarding network element at a district level, and the second deployment requirement information indicates that the function image is to be deployed on the first processing network element at a city level, the first network element may deploy the service flow identification model on one or more first forwarding network elements at the district level in a hotspot area, and deploy the function image on one or more first processing network elements at the city level in the hotspot area.

In an optional implementation, the step in which the second network element receives the deployment request information from the application provider may specifically include: The second network element receives deployment request information that has been verified from a third network element, where the third network element is configured to verify information from the application provider.

In embodiments of this application, the third network element (for example, an NEF) verifies the deployment request information, so that security of network exposure can be improved, and a person can be prevented from attacking the network by masquerading as the application provider, or the application provider can be notified in time when the network cannot meet the requirement of the request information.

According to a fourth aspect, an embodiment of this application provides a communication system. The communication system includes a first network element and a first forwarding network element. The first forwarding network element is configured to perform the communication method according to the first aspect, and the first network element is configured to perform the method according to the second aspect.

In a possible implementation, the communication system further includes a second network element. The second network element is configured to perform the method according to the third aspect.

According to a fifth aspect, an embodiment of this application provides a communication apparatus. The communication apparatus includes a processor. The processor is configured to: execute a computer program (or computer-executable instructions) stored in a memory, and/or enable, by using a logic circuit, the apparatus to perform the method according to any one of the first aspect and the possible implementations of the first aspect, the method according to any one of the second aspect and the possible implementations of the second aspect, or the method according to any one of the third aspect and the possible implementations of the third aspect.

In a possible implementation, the apparatus further includes the memory.

In a possible implementation, the processor and the memory are integrated together.

In another possible implementation, the memory is located outside the communication apparatus.

In a possible implementation, the communication apparatus further includes a communication interface. The communication interface is configured for the communication apparatus to communicate with another device, for example, send or receive data and/or a signal. For example, the communication interface may be a transceiver, a circuit, a bus, a module, or another type of communication interface.

For example, the communication interface may receive data from the memory.

According to a sixth aspect, this application provides a computer-readable storage medium. The computer-readable storage medium stores a computer program, and when the computer program is run, the methods in the foregoing aspects are implemented.

According to a seventh aspect, a computer program product is provided. When the computer program product is executed on a computer, the computer performs the methods described in the foregoing aspects.

For beneficial effect of the fourth aspect to the seventh aspect, refer to the first aspect to the third aspect. Details are not described herein again.

### BRIEF DESCRIPTION OF DRAWINGS

FIG. 1a is a diagram of an architecture of a communication system according to this application;

FIG. 1b is a diagram of another architecture of a communication system according to this application;

FIG. 2 is a diagram of an open network architecture according to an embodiment of this application;

FIG. 3 is a schematic flowchart of a communication method according to an embodiment of this application;

FIG. 4 is a diagram of a data flow direction of a communication method according to an embodiment of this application;

FIG. 5 is a schematic flowchart of a communication method according to an embodiment of this application;

FIG. 6A and FIG. 6B are a schematic flowchart of a pre-deployed communication method according to an embodiment of this application;

FIG. 7 is a schematic flowchart of a communication method in which a location of a terminal changes according to an embodiment of this application;

FIG. 8 is a schematic flowchart of establishing a transmission channel according to an embodiment of this application;

FIG. 9 is another schematic flowchart of establishing a transmission channel according to an embodiment of this application;

FIG. 10 is a diagram of a structure of a communication apparatus according to an embodiment of this application; and

FIG. 11 is a diagram of another structure of a communication apparatus according to an embodiment of this application.

### DESCRIPTION OF EMBODIMENTS

The following describes embodiments of this application with reference to accompanying drawings.

In the specification, claims, and accompanying drawings of this application, the terms “first”, “second”, and so on are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, product, or device. In addition, “at least one” means one or more, and “a plurality of” means two or more. The term “and/or” is an association relationship for describing associated objects and represents that three relationships may exist. For example, A and/or B may represent the following three cases: Only A exists, both A and B exist, and only B exists. A and B may be singular or plural. The character “/” generally indicates an “or” relationship between the associated objects. At least one of the following items (pieces) or a similar expression thereof refers to any combination of these items, including any combination of singular items (pieces) or plural items (pieces). For example, at least one item (piece) of a, b, or c may represent a, b, c, a and b, a and c, b and c, or a, b, and c.

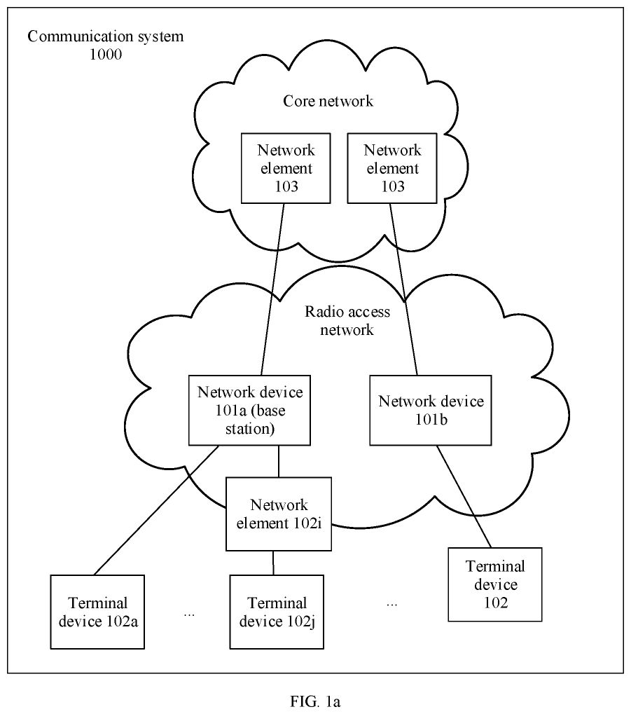

FIG. 1a is a diagram of an architecture of a communication system according to this application. The communication system 100 includes a core network and a radio access network (RAN). The core network is configured to provide a user connection, manage a user, and complete service bearing, and provide an interface to an external network as a bearer network. The radio access network is configured to implement access from a terminal device (which may also be referred to as a terminal for short) to the core network through an access network device. As shown in FIG. 1a, the radio access network includes a plurality of network devices 101, the network devices 101 are configured to connect to a terminal device 102, and the core network includes a plurality of network elements 103.

In embodiments of this application, both the network element 103 in the core network and the network device 101 in the radio access network may be referred to as a network element. A specific name of the network element is not limited in this application. The following names of the network elements are merely examples, and there may be other names in a subsequently evolved network. This is not limited in this application.

The network device 101 is a node in a radio access network (RAN), and may also be referred to as an access network device, or may be referred to as a RAN node (or device). The network device 101 is configured to assist the terminal in implementing radio access. The plurality of network devices 101 in the communication system 100 may be nodes of a same type, or may be nodes of different types.

In some scenarios, roles of the network device 101 and the terminal device 102 are relative. For example, the network element 102i in FIG. 1a may be a helicopter or an uncrewed aerial vehicle, and may be configured as a mobile base station. For a terminal 102j that accesses the RAN 100 through the network element 102i, the network element 102i is a base station. However, for the base station 101a, the network element 102i is a terminal. The network device 101 and the terminal 102 are sometimes both referred to as communication apparatuses. For example, the network devices 101a and 101b in FIG. 1a may be understood as communication apparatuses having a base station function, and the terminals 102a to 102j may be understood as communication apparatuses having a terminal function.

In a possible scenario, the network device 101 may be a base station, an evolved base station (eNodeB), a transmission reception point (TRP), a transmission point (TP), a next-generation NodeB (gNB), a next-generation base station in a 6th generation (6G) mobile communication system, a base station in a future mobile communication system, a satellite, an access point (AP) in a Wi-Fi system, an integrated access and backhaul (IAB) node, a network device that is in a non-terrestrial network (NTN) communication system of a mobile switching center and that may be deployed on a high-altitude platform or a satellite, or the like. The network device 101 may be a macro base station (for example, 110a in FIG. 1 a), a micro base station or an indoor station (for example, 110b in FIG. 1 a), a relay node or a donor node, or a radio controller in a cloud radio access network (CRAN) scenario. The network device 101 may alternatively be a device that serves as a base station function in device-to-device (D2D) communication, internet of vehicles communication, uncrewed aerial vehicle communication, or machine communication. Optionally, the network device 101 may alternatively be a server, a wearable device, a vehicle, a vehicle-mounted device, or the like. For example, an access network device in a vehicle-to-everything (V2X) technology may be a road side unit (RSU).

In another possible scenario, a plurality of network devices 101 collaborate to assist the terminal 102 in implementing wireless access, and different network devices 101 separately implement some functions of a base station. For example, the network device 101 may be a central unit (CU), a distributed unit (DU), a CU-control plane (CP), a CU-user plane (UP), a radio unit (RU), or the like. The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network (CN). This is not limited herein.

In different systems, the CU (or the CU-CP and the CU-UP), the DU, or the RU may alternatively have different names, but a person skilled in the art may understand meanings thereof. For example, in an open RAN (ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

The terminal device 102 may also be referred to as user equipment (UE), a mobile station (MS), a mobile terminal (MT), or the like, and is a device that provides a user with voice or data connectivity, or may be an internet of things device. For example, the terminal device 102 includes a handheld device, a vehicle-mounted device, or the like that has a wireless connection function. Currently, the terminal device may be a mobile phone, a tablet computer, a notebook computer, a palmtop computer, a mobile internet device (MID), a wearable device (for example, a smart watch, a smart band, a pedometer, or smart glasses), a vehicle-mounted device (for example, a car, a bicycle, an electric vehicle, an airplane, a ship, a train, or a high-speed train), a satellite terminal, a virtual reality (VR) device, an augmented reality (AR) device, a smart point of sale (POS) machine, customer-premises equipment (CPE), a wireless terminal in industrial control, a smart home device (for example, a refrigerator, a television, an air conditioner, or an electricity meter), a smart robot, a robot arm, a workshop device, a wireless terminal in self-driving, a wireless terminal in telemedicine, a wireless terminal in a smart grid, a wireless terminal in transportation safety, a wireless terminal in a smart city, a wireless terminal in a smart home, a flight device (for example, a smart robot, a hot air balloon, an uncrewed aerial vehicle, or an airplane), or the like. The terminal device 102 may alternatively be a vehicle apparatus, for example, a vehicle apparatus, an in-vehicle module, an in-vehicle chip, an on-board unit (OBU), or a telematics box (T-BOX). The terminal device 102 may alternatively be another device having a terminal function. For example, the terminal device 102 may alternatively be a device that serves as a terminal function in D2D communication.

A device form of the terminal device 102 is not limited in embodiments of this application. An apparatus configured to implement a function of the terminal device 102 may be the terminal device 102, or may be an apparatus that can support the terminal device 102 in implementing the function, for example, a chip system. The apparatus may be mounted in the terminal device 102 or used in cooperation with the terminal device 102. In embodiments of this application, the chip system may include a chip, or may include a chip and another discrete component.

In the system shown in FIG. 1a, a connection relationship between network elements is shown in FIG. 1b. The core network includes a plurality of network elements 103, for example, an access and mobility management function (AMF), unified data management (UDM), a session management function (SMF), a policy control function (PCF), a network slicing selection function (NSSF), a network exposure function (NEF), a network repository function (NRF), an application function (AF), an authentication server function (AUSF), an SCP, a user plane function (UPF), and a data network (DN) shown in FIG. 1b.

The AMF is mainly an access management function. The UDM is configured to implement user subscription data management, user identifier management, and the like. The SMF is mainly configured to establish and manage a session for a user, and configure a data packet forwarding rule and a QoS processing rule of a user name function. The PCF is mainly responsible for sending terminal policy information to the terminal, sending an access management policy of the terminal to the AMF, and sending a session management policy to the SMF. The user plane function (UPF) is responsible for forwarding user data, and the UDM stores subscription data of a user. The data network (DN) is a destination for accessing the user protocol data unit (PDU) session. The (R)AN is an access network, and the terminal accesses the core network through the access network.

An application provider (OTT) or an application service provider (for example, providing an application service, an application (APP) development platform, and the like for a user through the Internet) may communicate with the terminal through a mobile communication network, to provide an application service for the user. In embodiments of this application, the OTT and the application service provider are collectively referred to as an application provider. The application provider may provide the application service for the terminal through a server, a cloud server, or the like. The mobile communication network (also referred to as a network) is configured to implement communication between the server and the terminal.

With development of computer technologies, there are more and more types of application services, and some applications have increasingly higher requirements on servers and networks. For example, a type of service flow (for example, instant skill) in some games has a low delay requirement, and some application services (for example, VR video playing) of media playing software have a high bandwidth requirement. These requirements are service quality requirements for the network.

The server of the application provider cannot meet these requirements due to a long communication distance, insufficient computing power, or the like. Therefore, the server is deployed at a mobile edge computing (MEC) station or a marginal cloud (EC) station, and the MEC/EC provides an application service for the terminal. Because a communication distance between the terminal and the MEC/EC is less than a distance between the terminal and the central cloud, a lower delay and a higher bandwidth can be provided for the terminal.

However, because deployment costs of an MEC/EC node is high, a quantity of MEC/EC nodes is limited. In addition, to ensure a delay of accessing the MEC/EC by the terminal, a service range of each MEC/EC node is limited. If the terminal is outside the service range of the MEC/EC node, service quality of an application service provided for the terminal cannot be ensured. A deployment location of the MEC/EC is fixed. If the terminal leaves the service range of the MEC/EC node, a distance between the terminal and the MEC/EC node is increased, and the terminal cannot access the MEC/EC node in time. Consequently, a delay of the application service is increased, or service quality of the application service is affected in another aspect.

To resolve the foregoing problem, a solution provided in embodiments of this application is as follows: A network is used as a service platform/a capability exposure platform to support intelligent deployment of an application server or an application service, and the network can expose a capability to an application provider for use, to provide an application service for a user (for example, a terminal) of the application provider.

To reduce difficulty and costs of providing an edge application service for the user by the application provider, embodiments of this application provide a communication method, and a related device. According to the communication method provided in embodiments of this application, a service flow identification model and a function image of an application service are deployed on a network element in the network, and the network element in the network provides the application service for the terminal. The application provider only needs to provide the service flow identification model and the function image to use the network exposure function, without learning network exposure rules. According to the communication method provided in embodiments of this application, difficulty and costs of using the network exposure capability by the application provider are reduced, and enthusiasm of the application provider to use a network exposure capability can be improved.

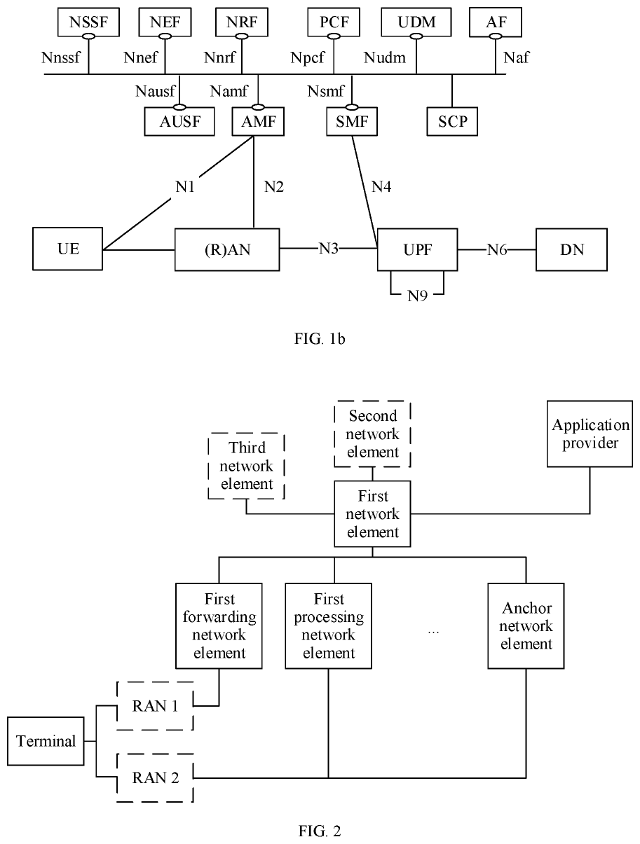

The communication method provided in embodiments of this application are applied to a network exposure platform shown in FIG. 2. As shown in FIG. 2, the network exposure platform includes a plurality of network elements, a terminal, and an application provider. The plurality of network elements include a first forwarding network element, a first processing network element, an anchor network element, a first network element, a second network element, and the like.

The first forwarding network element is configured to: load a service flow identification model of a target service; and identify and offload service data from the terminal based on the service flow identification model, forward service data of the target service to the first processing network element, and forward service data of a non-target service to the anchor network element. The first forwarding network element may be a network element such as a user plane function or an access network device, or may be another network element or network function that implements a corresponding function. This is not limited in this application. For example, the first forwarding network element may be an intermediate user plane function (I-UPF). For ease of description, the following uses an example in which the I-UPF is used as the first forwarding network element for description.

The first processing network element is configured to: load the function image of the target service, and process the service data of the target service based on the function image. The first processing network element may be a network element such as a UPF or a RAN, or may be another network element or network function that implements a corresponding function. This is not limited in this application. For example, the first processing network element may be a local anchor user plane function (LA-UPF). For ease of description, the following uses an example in which the LA-UPF is used as the first processing network element for description.

The anchor network element is configured to forward the service data of a non-target service to an application server of the service data, or is configured to process the service data of a non-target service. In embodiments of this application, a distance between the anchor network element and the terminal is greater than a distance between the first processing network element and the terminal. The anchor network element may be a network element such as a UPF or a RAN, or may be another network element or network function that implements a corresponding function. This is not limited in this application. For example, the anchor network element may be an anchor user plane function (A-UPF). For ease of description, the following uses an example in which the A-UPF is used as the anchor network element for description.

The first network element can configure, store, or obtain a network topology between the plurality of network elements. The first network element is configured to determine a deployment location (that is, the first forwarding network element) of the service flow identification model and a deployment location (that is, the first processing network element) of the function image. The first network element may be an SMF, or may be another network element or network function that implements a corresponding function. This is not limited in this application. For ease of description, the following uses an example in which the LA-UPF is used as the first processing network element for description.

A third network element is configured to verify an application request from the terminal. Optionally, the third network element may be an NEF.

Optionally, the first forwarding network element, the first processing network element, and the anchor network element may be connected to the terminal through a same RAN or different RANs. Optionally, the platform may further include a network exposure function NEF, the second network element, and the like. This is not limited in this application.

In an optional implementation, the I-UPF and the LA-UPF may be co-deployed, or may be a same UPF.

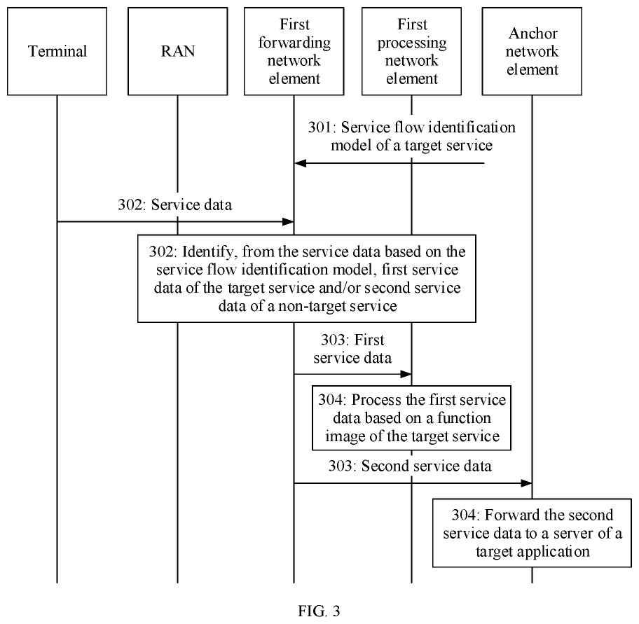

Based on the network exposure platform shown in FIG. 2, a procedure of the communication method provided in embodiments of this application is shown in FIG. 3. The communication method includes the following steps.

301: The first forwarding network element receives the service flow identification model of the target service.

The application provider or an application server may provide application services for the terminal. In the application services provided by the application provider, some services have a low requirement on service quality (for example, low delay processing is not required), and some services have a high requirement on service quality (for example, low delay processing is required). In embodiments of this application, a service that has a high requirement on service quality may be the target service. For example, the target service includes a service that requires a delay to be lower than a first threshold (for example, 100 milliseconds) and/or a service whose bandwidth is greater than a second threshold (for example, 500 megabytes), and the like. This is not limited in this application.

For example, if the application provider is a game vendor, the application service provided by the application provider is a game. The game includes services such as character texture, map update, and instant skill release. Character texture and map update have low requirements on service quality, and instant skill release has high requirements on service quality (for example, a delay). Therefore, instant skill release is a target service of the game.

The first forwarding network element (for example, the I-UPF) may receive the service flow identification model of the target service. The service flow identification model is used to identify the service data of the target service.

It should be noted that, from a perspective of deployment, the service flow identification model may be understood as an installation package, a template, or the like used to detect a target service data packet. From a perspective of execution, the service flow identification model may also be understood as an application service instance, a functional function, or the like that is loaded and executable.

Optionally, the service flow identification model may determine, by using a special flag bit (for example, an application ID or a service flow ID) in a frame header of a service data packet, whether service data is the service data of the target service. Optionally, in addition to the special flag bit, the service flow identification model may further identify the service data of the target service by using another method, for example, identify the service data of the target service by using a specific triplet or quintuplet. This is not limited in this application.

It should be noted that the first forwarding network element receives the service flow identification model in a model deployment phase. Because the model is deployed in a plurality of manners, a device from which the first forwarding network element receives the service flow identification model is not limited. Optionally, the first forwarding network element may receive the service flow identification model from the first network element, the application provider, the second network element, or a database. This is not limited in this application.

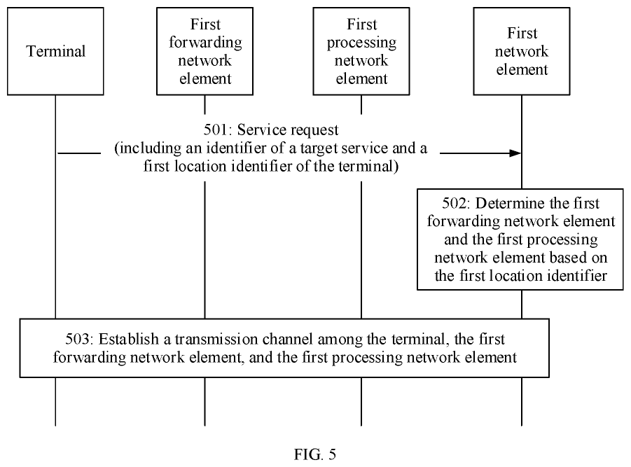

FIG. 3 describes specific execution processes of the first forwarding network element and the first processing network element. For deployment processes of the first forwarding network element and the first processing network element, refer to the embodiments shown in FIG. 5 to FIG. 8.

302: The first forwarding network element receives the service data from the terminal, and identifies, from the service data based on the service flow identification model, first service data of the target service and/or second service data of a non-target service.

The service flow identification model is used to identify the service data of the target service. Therefore, the first forwarding network element may classify, based on the service flow identification model, the service data from the terminal into the first service data of the target service and the second service data that is not of the-target service.

For example, in the foregoing example of the game, the first forwarding network element identifies, from the service data from the terminal based on a service flow identification model of an instant skill release service, first service data of the instant skill release service and second service data of a non-instant skill release service.

Optionally, the second service data and the first service data may be service data of different services in a same application, or may be service data of different applications. This is not limited in this application.

303: The first forwarding network element forwards the first service data to a first processing network element, and/or forwards the second service data to an anchor network element.

In embodiments of this application, the first processing network element (for example, the LA-UPF) is configured to process the service data (the first service data) of the target service, to meet a service quality requirement of the target service. Therefore, the first forwarding network element forwards the first service data to the first processing network element.

Because services other than the target service have a low requirement on service quality, service data (the second service data) of other services may be forwarded to an application server in a central cloud for processing. Therefore, the first forwarding network element forwards the second service data to the anchor network element (also referred to the A-UPF), to forward the second service data to the application server through the anchor network element. Optionally, the second service data may alternatively be locally processed by the anchor network element. This is not limited in this application.

304: The first processing network element processes the first service data based on the function image of the target service, and/or the anchor network element forwards the second service data to an application server of the second service data.

The function image of the target service is deployed on the first processing network element. Therefore, after receiving the first service data, the first processing network element may process the first service data based on the function image of the target service.

It should be noted that, from a perspective of deployment, the function image may be understood as a target service installation package, an instance template, or the like. From a perspective of execution, the function image may also be understood as an application service instance, a functional function, or the like that is loaded and executable.

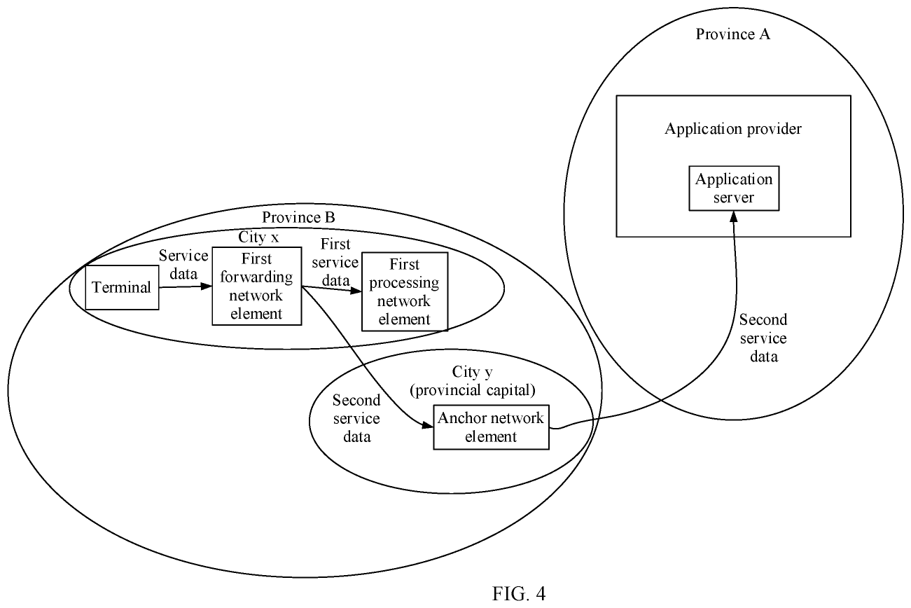

From a perspective of geographical area distribution, the anchor network element may be closer to a central cloud/Internet than the first forwarding network element (and the first processing network element), or the anchor network element may have a wider service range than the first forwarding network element (and the first processing network element). For example, as shown in FIG. 4, an application server of an application provider is deployed in a provincial capital city S of a province A, and supports access of terminals in each city of the province A. When a terminal in a city x of the province A attempts to access the application server, the first forwarding network element and the first processing network element may be UPFs deployed in the city x, and the anchor network element may be a UPF deployed in the city S. The UPF in the city x may be connected to the UPF in the city S. When the terminal accesses a network in the city x, a service that requires low delay processing may be terminated and processed by the UPF in the city x, and a service that does not require low delay processing may be forwarded to the UPF in the city S for processing or forwarded to the central cloud/Internet by the UPF in the city S.

The application server of the second service data is deployed on the anchor network element or the central cloud/Internet. If the application server is deployed on the central cloud/Internet, after receiving the second service data, the anchor network element may forward the second service data to the application server (the central cloud/Internet) of the second service data. If the application server is deployed on the anchor network element, after receiving the second service data, the anchor network element may locally process the second service data. This is not limited in this application.

In embodiments of this application, the first forwarding network element on which the service flow identification model is deployed is used to offload the service data from the terminal. The first service data that has a high service quality requirement in the service data is forwarded to a closer first processing network element for processing, and the second service data that has a low service quality requirement in the service data is forwarded to a farther application server through the anchor network element for processing (or locally processed by the anchor network element), thereby implementing traffic offloading. In comparison with the application server deployed on the anchor network element or the central cloud/Internet, the first processing network element has a shorter communication distance with the terminal, and processes a small amount of data (the application processor needs to process service data in various places, and the first processing network element only needs to cover service data within a service range). Therefore, the first processing network element can provide a high quality application service for the terminal, thereby ensuring service quality of the application service.

Optionally, if there are a plurality of services in the application that have high requirements on service quality, the service flow identification model may also be used to identify a plurality of types of first service data. For example, for services of a same game application, the instant skill release service has a high requirement on a delay, and an image rendering service has a high requirement on a bandwidth. In this case, in step 302, the first forwarding network element may identify the service data (which is the first service data) of the two services based on the service flow identification model, and send the first service data to the first processing network element in step 303.

Optionally, different first processing network elements may be further used to meet service quality requirements of different target services. For example, the instant skill release service has the high requirement on the delay, and the image rendering service has the high requirement on the bandwidth. In this case, in step 303, the first forwarding network element forwards service data of the instant skill release service to a first processing network element-1, and forwards service data of the image rendering service to a first processing network element-2. A transmission distance between the first forwarding network element and the first processing network element-1 is short, so that a low delay requirement can be met. A communication bandwidth between the first forwarding network element and the first processing network element-2 is large, so that a high bandwidth requirement can be met.

The embodiments shown in FIG. 3 and FIG. 4 describe how the network capability exposure platform provided in embodiments of this application offloads service data by using the first forwarding network element, to ensure service quality of a service with a high requirement. The following describes a process of determining the first forwarding network element and the first processing network element, that is, a scheduling process of deployment locations of the service flow identification model and the function image. For ease of description, this is also referred to as a scheduling process.

As shown in FIG. 5, in the communication method provided in embodiments of this application, the scheduling process includes the following steps.

501: A first network element receives a service request, where the service request includes an identifier of a target application and a first location identifier of a terminal.

Optionally, the first network element may be a network element such as a session management function, a policy control function, or a control network element of an access network element, or may be another network element or network function that implements a corresponding function. This is not limited in this application. For ease of description, the following provides description by using an example in which the session management function SMF is the first network element.

The terminal sends the service request to an access network device. After receiving the service request, the access network device sends the service request and a location identifier of the terminal to the first network element. For example, the access network device encapsulates the service request and the location identifier of the terminal, and then sends the encapsulated service request and location identifier to the first network element.

In an optional implementation, the location identifier of the terminal may be an identifier of a radio access network accessed by the terminal.

In an optional implementation, if the service request sent by the terminal includes the location identifier of the terminal, the access network device may directly forward the service request to the first network element.

The SMF receives the service request of the terminal, where the service request includes the identifier of the target application and the first location identifier of the terminal. It should be noted that the first location identifier of the terminal may be sent by the terminal, or may be sent by another network element such as an access network device RAN or an access and mobility management function AMF. To be specific, in an implementation, the terminal sends the service request of the terminal, where the service request includes the first location identifier of the terminal. In another implementation, the terminal sends the service request of the terminal, where the service request does not include the first location identifier of the terminal. In a process in which the service request is sent to the SMF through another network element such as a RAN/AMF, the RAN/AMF adds the first location identifier of the terminal, so that the service request of the terminal received by the SMF includes the first location identifier of the terminal.

In a possible implementation, the service request may be a session establishment request, a target application service request, a connection establishment request, or the like. This is not limited in this application.

In a possible implementation, the first location identifier may be an identifier/cell identifier of an access network device serving the terminal, a longitude and latitude identifier of the terminal, an identifier of a geographical area in which the terminal is located, or another type of identifier. This is not limited in this application.

502: The first network element determines a first forwarding network element and a first processing network element based on the first location identifier.

The SMF may determine, based on the identifier of the target application in the service request, whether there is a target service that has a high service quality requirement in the target application. Optionally, before step 502, the SMF may receive and store a mapping relationship between the target application and the target service; and after receiving the service request, the SMF may query the mapping relationship based on the identifier of the target application, to determine the target service of the target application.

For example, the instant skill release service in the game application is the target service with the high service quality requirement. In a process of releasing a game online, the SMF may obtain a mapping relationship between the game application and the instant skill release service. Each time a service request including the identifier of the target application is received, it may be determined that the first forwarding network element needs to be deployed to offload service data (as shown in FIG. 3 and FIG. 4) of the target service.

Specifically, the SMF determines, based on the first location identifier of the terminal in the service request, the first forwarding network element used to deploy the service flow identification model and the first processing network element used to deploy the function image. For example, the first location identifier indicates that the terminal is located in a district m of a city x in a province B. The SMF may determine a first forwarding network element and a first processing network element in the district m, or determine a first forwarding network element in the district m and a first processing network element in the city x.

Optionally, in a process of determining the first forwarding network element and the first processing network element, a distance between the first forwarding network element and the terminal may be less than a distance between the first processing network element and the terminal. For example, the SMF may set the first forwarding network element in the district m, set the first processing network element in the city x, and determine that the first forwarding network element is connected to the first processing network element.

In embodiments of this application, compared with the first forwarding network element, the first processing network element may support a wider service coverage. Therefore, first service data of a plurality of first forwarding network elements may be forwarded to a same first processing network element for processing, thereby fully utilizing computing power of the first processing network element.

In a possible implementation, in embodiments of this application, the first forwarding network element and the first processing network element may be determined based on a connection relationship with the access network device, in addition to a geographical area. For example, in a plurality of access network devices whose coverage areas include the location of the terminal, a UPF that is close to an access network device accessed by the terminal is determined as the first forwarding network element, and a UPF connected to the first forwarding network element is determined as the first processing network element, where a distance between the first processing network element and the access network device is greater than a distance between the first forwarding network element and the access network device.

In a possible implementation, the access network device accessed by the terminal is determined as the first forwarding network element, and the UPF that is close to the access network device accessed by the terminal is determined as the first processing network element.

In a possible implementation, before step 502, the first network element may further obtain second deployment requirement information of the target service. The second deployment requirement information indicates a requirement of the target service, and may specifically include service quality information of the target service, and the like. This is not limited in this application. The service quality information may include delay requirement information, bandwidth requirement information, computing resource requirement information, a service layer agreement (SLA), or the like.

For example, if a delay requirement of the target service is 100 ms, the second deployment requirement information may include delay requirement information of 100 ms. Deployment locations of different UPFs may correspond to different delays, and the UPFs may be determined based on delay requirements. For example, if a delay of a city level UPF is approximately at a level of 300 ms, and a delay of a district level UPF is approximately at a level of 100 ms, the first forwarding network element and/or the first processing network element may be determined from UPFs in a district in which the terminal is located based on the delay requirement.

Optionally, the second deployment requirement information may be from the terminal, an application server, an application server controller, or the like. This is not limited in this application.

503: The first network element establishes a transmission channel among the terminal, the first forwarding network element, and the first processing network element.

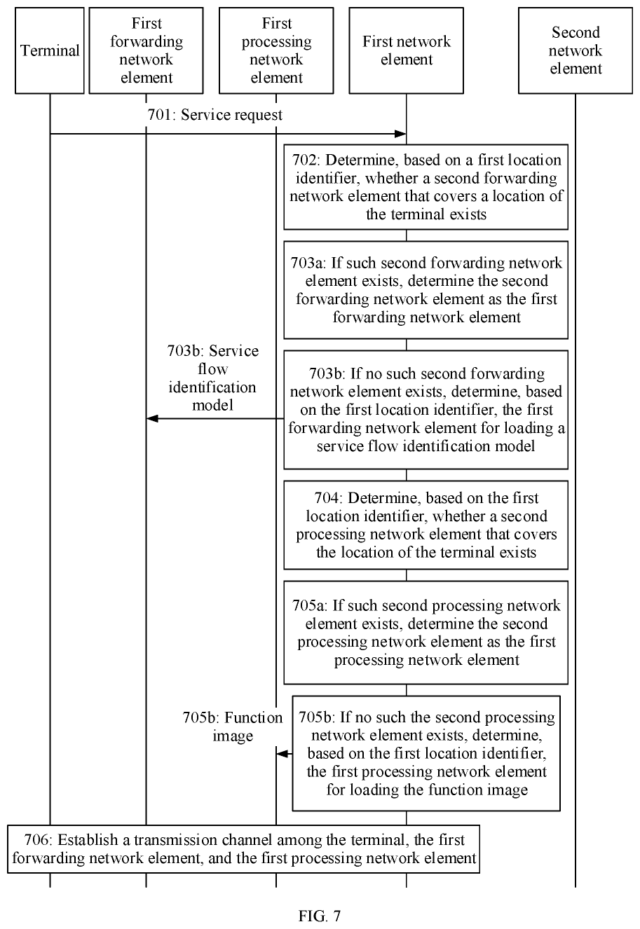

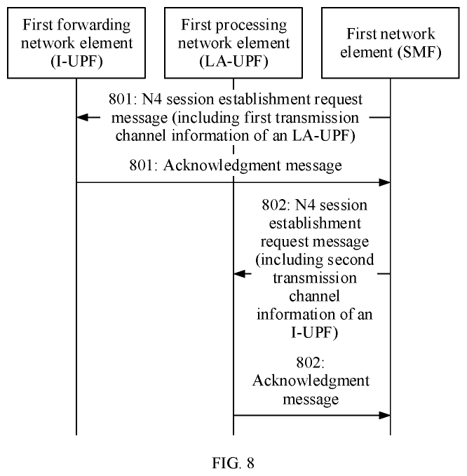

After the first forwarding network element and the first processing network element are determined, the first network element may establish the transmission channel among the terminal, the first forwarding network element, and the first processing network element. Optionally, establishment of the transmission channel may be initiated by the first forwarding network element (I-UPF), the first processing network element (LA-UPF), or the first network element (SMF). This is not limited in this application. The corresponding embodiments are described in detail in FIG. 8 and FIG. 9.

After the scheduling process shown in FIG. 5 is completed, the first forwarding network element and the first processing network element may be determined, and then the service data is offload and processed by using the offloading processes described in FIG. 3 and FIG. 4.

In embodiments of this application, the first network element determines, based on the location of the terminal, the first forwarding network element (for example, the I-UPF) used to deploy the service flow identification model and the first processing network element (for example, the LA-UPF) used to deploy the function image. Network elements (for example, network elements such as an access network device and a UPF) have been widely deployed in a mobile communication network, to provide a ubiquitous service for the terminal. As long as the terminal moves within coverage of the mobile communication network, the first forwarding network element and the first processing network element can be determined for the terminal, and an application service with high service quality can be provided for the terminal by using the first forwarding network element and the first processing network element. According to the communication method provided in embodiments of this application, an area with high service quality of the target service can be expanded, and a high quality service can be basically implemented within coverage of a mobile network. In addition, an operator or a service provider does not need to purchase computing and storage resources again, and does not need to establish a network pipe. This can reduce costs of the service provider, expand the pipe of the network operator, and help the operator monetize resources. In addition, in the mobile communication network, service ranges of different network elements (for example, UPFs) are divided at a finer granularity, thereby shortening a distance between the terminal and a data processing apparatus (originally, the distance is from the terminal to the application server, and in embodiments of this application, the distance is only from the terminal to the first processing network element). The service ranges are divided at a fine granularity (for example, by street or by cell), so that a communication distance between the terminal and the first processing network element is short, thereby improving an upper limit of service quality of the target service by shortening the communication distance.

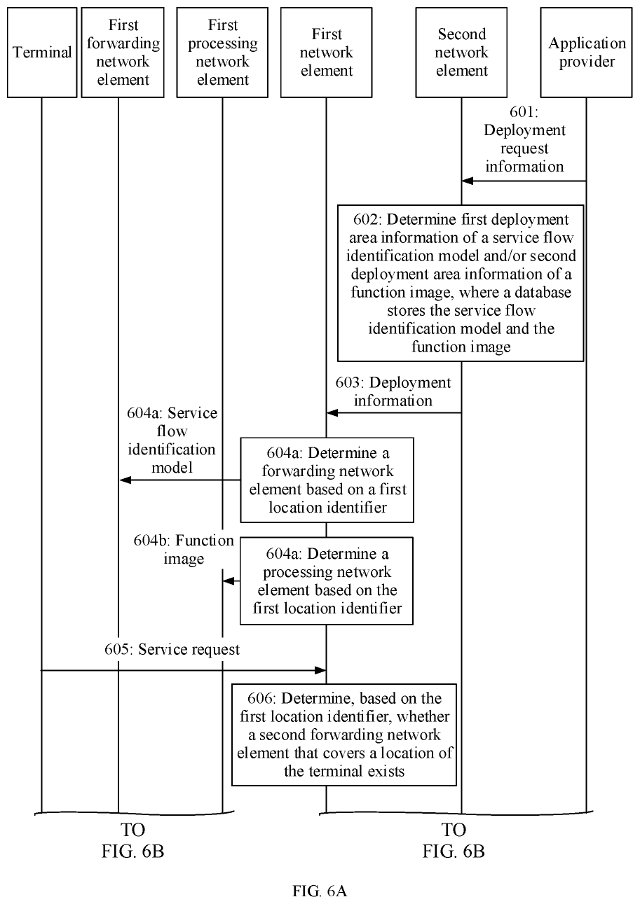

The following describes a deployment process of the first forwarding network element and the first processing network element. A specific procedure is shown in FIG. 6A and FIG. 6B. In the communication method provided in embodiments of this application, a deployment procedure of the first forwarding network element and the first processing network element includes the following steps.

601: A second network element receives deployment request information from the application provider.

If determining that some services in the application have a high requirement on service quality, the application provider may send the deployment request information to the second network element. The deployment request information includes a service flow identification model of the target service and/or a function image of a target service. The deployment request information is used to request the network to deploy the service flow identification model and/or the function image of the target service in the network.

In a possible implementation, the deployment request information may further include first deployment requirement information of the service flow identification model and/or second deployment requirement information of the function image. The first deployment requirement information may include a preferred deployment area of the service flow identification model, a resource requirement such as computing and storage required for deploying the model, and the like. The second deployment requirement information may include a preferred deployment area of the function image, a resource requirement such as computing and storage required for deploying the image, and the like. This is not limited in this application.

In a possible implementation, the deployment request information may alternatively be sent by the application provider to an NEF. The NEF forwards the deployment request information to the second network element only after determining that the deployment request information passes verification, and directly discards the information if the deployment request information fails verification. The NEF verifies the deployment request information, so that security of network exposure can be improved, and an attacker can be prevented from attacking the network by masquerading as the application provider, or the application provider can be notified in time when the network cannot meet the requirement of the request information.

Optionally, in addition to the NEF, another network element or network function may be used to verify the deployment request information. This is not limited herein.

602: The second network element determines first deployment area information of the service flow identification model and/or second deployment area information of the function image, and stores the service flow identification model and the function image in a database.

If the deployment request information includes the service flow identification model, the second network element determines the first deployment area information of the service flow identification model. The first deployment area information indicates a deployment area of the service flow identification model, for example, a district or a city. Optionally, if the deployment request information includes the first deployment requirement information, the second network element may determine the first deployment area information based on a hotspot area indicated by the first deployment requirement information.

If the deployment request information includes the function image, the second network element determines the second deployment area information of the function image. The second deployment area information indicates a deployment area of the function image, for example, a district or a city. Optionally, if the deployment request information includes the second deployment requirement information, the second network element may determine the second deployment area information based on the hotspot area indicated by the second deployment requirement information.

The second network element may further store the service flow identification model and/or the function image in the deployment request information in the database.

Optionally, the database may be a part of the second network element, or may be a network element independent of the second network element. This is not limited in this application.

603: The second network element sends deployment information to the first network element.

After the first deployment area information of the service flow identification model and/or the second deployment area information of the function image are/is determined, the second network element may send the deployment information to the first network element, where the deployment information includes the first deployment area information and/or the second deployment area information. The deployment information indicates the first network element to determine, within the first deployment area indicated by the deployment information, a first forwarding network element for deploying the service flow identification model, and to determine, within the second deployment area indicated by the deployment information, the first processing network element for deploying the function image.

In embodiments of this application, the second network element is configured to determine or manage pre-deployment areas of the first forwarding network element and the first processing network element. The second network element may be referred to as a deployment control network element or a deployment management network element, and the name is not limited. Optionally, the second network element may be integrated with the first network element as a functional module or a network element. For example, if the first network element is an SMF, the second network element may be a module on the SMF responsible for determining the deployment area. If the first network element and the second network element are integrated, step 601 and step 602 are performed by the first network element, and step 603 is omitted.

604a: The first network element determines a forwarding network element based on the first deployment area information, and sends the service flow identification model to the forwarding network element.

If the deployment information includes the first deployment area information, the first network element may determine a forwarding network element based on the first deployment area information. For example, if the first deployment area information is an identifier of an mth area, the first network element may determine, within the mth area, a forwarding network element for deploying the service flow identification model.

Then, the first network element obtains the service flow identification model from a database and sends the service flow identification model to the determined forwarding network element, so as to deploy the service flow identification model on the forwarding network element.

It should be noted that, after the first network element sends the service flow identification model to the forwarding network element, the forwarding network element allocates necessary computing and storage resources to run the service flow identification model, turning the model into an executable function, a detection rule, an application instance, or the like.

604b: The first network element determines a processing network element based on the second deployment area information, and sends the function image to the processing network element.

If the deployment information includes the second deployment area information, the first network element may determine a processing network element based on the second deployment area information. For example, if the second deployment area information is an identifier of a city x, the first network element may determine, within the city x, a processing network element for deploying the function image.

Then, the first network element obtains the function image from a database and sends the function image to the determined processing network element, so as to deploy the function image on the processing network element.

It should be noted that, after the first network element sends the function image to the first processing network element, the forwarding network element allocates necessary computing and storage resources to run the function image, turning the function image into an executable function, an application instance, or the like.

605: The first network element receives a service request.

For step 605, refer to step 501 in the embodiment shown in FIG. 5. Details are not described herein again.

606: The first network element determines, based on the first location identifier, whether a second forwarding network element that covers a location of the terminal exists, where the second forwarding network element has loaded the service flow identification model.

The first network element determines, based on the first location identifier, the location of the terminal, and determines whether the location of the terminal is covered by a network element that has loaded the service flow identification model. In embodiments of this application, a network element that has loaded the service flow identification model and whose service area covers the location of the terminal is referred to as a second forwarding network element.

607a: If such second forwarding network element exists, determine the second forwarding network element as the first forwarding network element.

If such second forwarding network element exists, it indicates that the service flow identification model has been deployed in the area where the terminal is currently located, specifically on the second forwarding network element. In this way, the first network element determines to use the second forwarding network element to offload the service data from the terminal (for a specific offloading process, refer to the descriptions in FIG. 3 and FIG. 4). In other words, in this case, the second forwarding network element is determined as the first forwarding network element for which a transmission channel is to be subsequently established. The transmission channel is the channel among the terminal, the first forwarding network element, and the first processing network element.

607b: If no such second forwarding network element exists, determine, based on the first location identifier, the first forwarding network element for loading the service flow identification model.

If no such second forwarding network element exists, it indicates that the service flow identification model has not yet been deployed in the area where the terminal is currently located, and the service flow identification model needs to be deployed based on the first location identifier. Specifically, the first network element determines, based on the first location identifier, the first forwarding network element for loading the service flow identification model. For details on determining the first forwarding network element, refer to step 502 in the embodiment shown in FIG. 5. Details are not described herein again.

In addition, the first network element further needs to send the service flow identification model to the first forwarding network element.

Optionally, if the first deployment area information and the second deployment area information indicated in the deployment information in step 603 include the location of the terminal, the location of the terminal is covered by the network element that has loaded the service flow identification model, that is, there is the second forwarding network element, and step 607a is performed; or if the first deployment area information and the second deployment area information indicated in the deployment information in step 603 do not include the location of the terminal, the location of the terminal is not covered by the network element that has loaded the service flow identification model, that is, there is not the second forwarding network element, and step 607b is performed.

608: The first network element determines, based on the first location identifier, whether the second processing network element that covers the location of the terminal exists, where the second processing network element has loaded the service flow identification model.

609a: If such second processing network element exists, determine the second processing network element as the first processing network element.

609b: If no such second processing network element exists, determine, based on the first location identifier, the first processing network element for loading the function image.

Similarly, whether the function image has been loaded at the location of the terminal is determined based on the first location identifier. If the function image has been loaded, it is determined the second processing network element as the first processing network element. If the function image has not been loaded, the function image is deployed. Content of steps 608, 609a, and 609b is similar to that of steps 606, 607a, and 607b, and details are not described herein again.

610: Establish a transmission channel among the terminal, the first forwarding network element, and the first processing network element.

For step 605, refer to step 503 in the embodiment shown in FIG. 5. Details are not described herein again.

In embodiments of this application, the application provider only needs to send one piece of deployment request information to the second network element, and include the service flow identification model and the function image of the target service in the deployment request information, so that an exposure capability of the mobile communication network can be used. The application provider deploys the function image on a network, and does not need to deploy an edge cloud by itself, thereby greatly reducing costs. In addition, the application provider has a low threshold for using a network exposure capability, and does not need to learn a complex network architecture and rule, thereby improving enthusiasm of the application provider for using the network exposure capability.

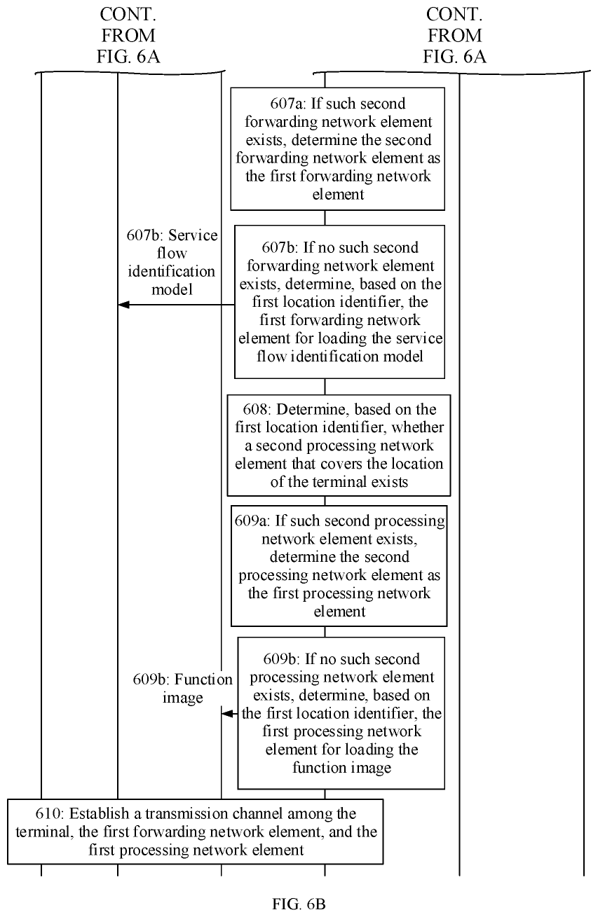

Optionally, when the terminal switches to a network device to be accessed, whether a location of a moved terminal is covered by a network element that has loaded a service flow identification model may be first determined, and then whether the first forwarding network element (I-UPF) and/or the first processing network element (LA-UPF) need to be temporarily deployed is determined. A corresponding procedure is shown in FIG. 7, and specifically includes the following steps.

701: A first network element receives a service request.

The service request is an access request, a cell handover request, or a service request (service request) of the terminal on a new access network device.

After receiving the service request, the access network device sends the service request and a location identifier of the terminal to the first network element. For example, the access network device encapsulates the service request and the location identifier of the terminal, and then sends the encapsulated service request and location identifier to the first network element.

In an optional implementation, the location identifier of the terminal may be an identifier of a radio access network accessed by the terminal.

In an optional implementation, if the service request sent by the terminal includes the location identifier of the terminal, the access network device may directly forward the service request to the first network element.

The service request received by the first network element includes an identifier of the target application and a first location identifier of the terminal. For a forwarding process of the service request, refer to step 501. Details are not described herein again.

702: The first network element determines, based on the first location identifier, whether a second forwarding network element that covers a location of the terminal exists, where the second forwarding network element has loaded the service flow identification model.

703a: If such second forwarding network element exists, determine the second forwarding network element as the first forwarding network element.

703b: If no such second forwarding network element exists, determine, based on the first location identifier, the first forwarding network for loading the service flow identification model.

704: The first network element determines, based on the first location identifier, whether the second processing network element that covers the location of the terminal exists, where the second processing network element has loaded the service flow identification model.

705a: If such second processing network element exists, determine the second processing network element as the first forwarding network element.

705b: If no such second processing network element exists, determine, based on the first location identifier, the first processing network element for loading the function image.

706: Establish a transmission channel among the terminal, the first forwarding network element, and the first processing network element.

For step 702 to step 706, refer to step 606 to step 610 in the embodiment shown in FIG. 6A and FIG. 6B. Details are not described herein again.

In a possible implementation, in step 503 in the embodiment shown in FIG. 5, step 610 in the embodiment shown in FIG. 6A and FIG. 6B, and step 706 in the embodiment shown in FIG. 7, the transmission channel may be allocated by an SMF or a UPF.

As shown in FIG. 8, a case in which the SMF allocates the transmission channel includes the following steps.

801: The SMF sends an N4 session establishment request message to an I-UPF, where the message includes first transmission channel information of an LA-UPF. Correspondingly, the I-UPF returns an acknowledgment message to the SMF.

The SMF may establish a transmission channel between the I-UPF and the LA-UPF. Specifically, the SMF may allocate tunnel identifiers to the I-UPF and the LA-UPF, where two ends of the tunnel are the I-UPF and the LA-UPF. The SMF sends the tunnel identifier and address information of the LA-UPF to the I-UPF. The I-UPF may send first service data to the LA-UPF based on the address information of the LA-UPF, to establish the transmission channel from the I-UPF to the LA-UPF.

Specifically, the SMF sends the N4 session establishment request message to the I-UPF, where the message includes the tunnel identifier (for example, TEID 1) and the address information (for example, an IP address) of the LA-UPF. The address information of the LA-UPF is also referred to as first transmission channel information, and the first transmission channel information indicates the first forwarding network element to forward the first service data to the first processing network element through a first transmission channel (an uplink direction of the tunnel, that is, a transmission channel from the I-UPF to the LA-UPF). Correspondingly, the I-UPF returns the acknowledgment message to the SMF.

In a possible implementation, the tunnel identifier may be a tunnel endpoint identifier (TEID), and the address information of the LA-UPF may be an IP address of the LA-UPF.

802: The SMF sends the N4 session establishment request message to the LA-UPF, where the message includes second transmission channel information of the I-UPF. Correspondingly, the LA-UPF returns an acknowledgment message to the SMF.

The SMF may send the tunnel identifier and the address information of the I-UPF to the LA-UPF. The LA-UPF may send third service data in a downlink direction of the target service to the I-UPF based on the address information of the I-UPF, to establish the transmission channel from the LA-UPF to the I-UPF.

The SMF may determine that an endpoint in the downlink direction of the tunnel is the I-UPF, and send the N4 session establishment request message to the LA-UPF, where the message includes the tunnel identifier (for example, TEID 2) and the address information (for example, an IP address) of the I-UPF. The address information of the I-UPF is also referred to as second transmission channel information, and the second transmission channel information indicates the first processing network element to forward the third service data (downlink service data) of the target service to the first forwarding network element through the second transmission channel (the downlink direction of the tunnel, that is, the transmission channel from the LA-UPF to the I-UPF). Correspondingly, the LA-UPF returns the acknowledgment message to the SMF.

The tunnel information may correspond to the terminal. Therefore, after receiving the third service data, the I-UPF may transmit the third service data to the terminal corresponding to the tunnel information, so that the third service data is transmitted from the first processing network element to the terminal.

In a possible implementation, the tunnel identifier may be the tunnel endpoint identifier TEID, and the address information of the I-UPF may be the IP address of the I-UPF.

According to the embodiment shown in FIG. 8, both the uplink direction and the downlink direction of the tunnel between the I-UPF and the LA-UPF can be established, and the transmission channel between the I-UPF and the LA-UPF can be established.

As shown in FIG. 9, a case in which the UPF allocates the transmission channel includes the following steps.

901: An SMF sends an N4 session establishment request message to an I-UPF. Correspondingly, the I-UPF allocates second transmission channel information, and returns a response message to the SMF, where the response message includes the second transmission channel information of the I-UPF.

The SMF sends an N4 session establishment request message to the I-UPF, to request the I-UPF to allocate a tunnel. The I-UPF may determine a tunnel identifier (for example, a TEID 2) and address information (for example, an IP address) of the I-UPF, and include the tunnel identifier and the address information of the I-UPF in the response message sent to the SMF.

The address information of the I-UPF is also referred to as second transmission channel information, and the second transmission channel information indicates the first processing network element to forward the third service data (downlink service data) of the target service to the first forwarding network element through the second transmission channel (the downlink direction of the tunnel, that is, the transmission channel from the LA-UPF to the I-UPF).

In a possible implementation, the tunnel identifier may be the tunnel endpoint identifier TEID, and the address information of the I-UPF may be the IP address of the I-UPF.

902: The SMF sends the N4 session establishment request message to the LA-UPF, where the message includes second transmission channel information of the I-UPF. Correspondingly, the LA-UPF allocates the first transmission channel information, and returns a response message to the SMF, where the response message includes the first transmission channel information of the LA-UPF.

The N4 session establishment request message sent by the SMF to the LA-UPF includes a tunnel identifier (for example, a TEID 2) and address information of the I-UPF (that is, the second transmission channel information). The LA-UPF may send third service data in a downlink direction of the target service to the I-UPF based on the address information of the I-UPF, to establish the transmission channel from the LA-UPF to the I-UPF.

The tunnel information may correspond to the terminal. Therefore, after receiving the third service data, the I-UPF may transmit the third service data to the terminal corresponding to the tunnel information, so that the third service data is transmitted from the first processing network element to the terminal.

The LA-UPF may determine that the endpoint in the uplink direction of the tunnel is the LA-UPF, so that the response message sent to the SMF includes the tunnel identifier (TEID 1) and the address information (for example, an IP address) of the LA-UPF.

In a possible implementation, the tunnel identifier may be a tunnel endpoint identifier TEID, and the address information of the LA-UPF may be the IP address of the LA-UPF.

903: The SMF sends an N4 session update request message to the I-UPF, where the message includes the first transmission channel information of the LA-UPF.

The N4 session update request message received by the I-UPF includes the tunnel identifier and the address information of the LA-UPF. The I-UPF may send first service data to the LA-UPF based on the address information of the LA-UPF, to establish the transmission channel from the I-UPF to the LA-UPF.

According to the embodiment shown in FIG. 9, both the uplink direction and the downlink direction of the tunnel between the I-UPF and the LA-UPF can be established, and the transmission channel between the I-UPF and the LA-UPF can be established.

A procedure for establishing a transmission channel between the RAN and the I-UPF is the same as that in the embodiments shown in FIG. 8 and FIG. 9. Details are not described herein again.

To implement the functions in the method provided in embodiments of this application, the first forwarding network element, the first network element, and the second network element may each include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

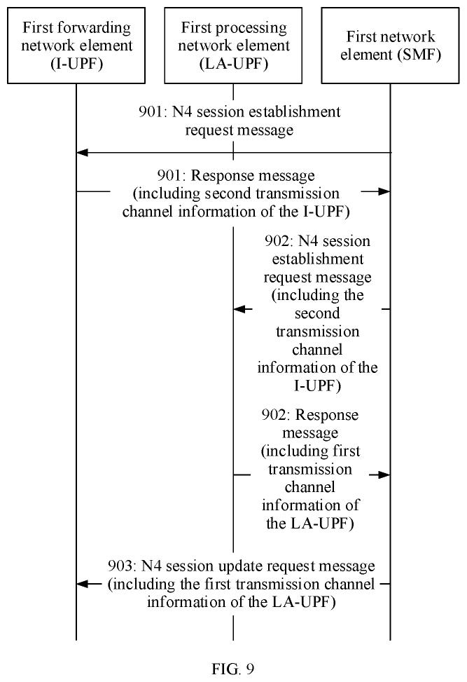

FIG. 10 shows a communication apparatus 1000 according to an embodiment of this application. The communication apparatus 1000 may be a network element, or may be an apparatus in a network element, or may be an apparatus that can be used together with a network element. In a possible implementation, the communication apparatus 1000 may include modules or units that are in one-to-one correspondence with the methods/operations/steps/actions performed by the first forwarding network element, the first network element, and the second network element in the foregoing method embodiments. The unit may be implemented by using a hardware circuit, software, or a combination of a hardware circuit and software. In a possible implementation, the communication apparatus 1000 may include a processing unit 1010 and a transceiver unit 1020. The processing unit 1010 may be configured to invoke the transceiver unit 1020 to perform a receiving function and/or a sending function.

When the communication apparatus 1000 is configured to perform an operation performed by the first forwarding network element, the transceiver unit 1020 is configured to: receive a service flow identification model of a target service, and receive service data from a terminal. The processing unit 1010 is configured to identify, from service data based on the service flow identification model, first service data of the target service and/or second service data of a non-target service. The transceiver unit 1020 is further configured to forward first service data to the first processing network element, and forward second service data to the anchor network element.

In a possible implementation, the transceiver unit 1020 is configured to receive first transmission channel information, where the first transmission channel information indicates the first forwarding network element to forward the first service data to the first processing network element through a first transmission channel.

In a possible implementation, the transceiver unit 1020 is configured to send second transmission channel information, where the second transmission channel information indicates the first processing network element to forward third service data of the target service to the first forwarding network element through a second transmission channel.

When the communication apparatus 1000 is configured to perform an operation performed by the first network element, the transceiver unit 1020 is configured to receive a service request, where the service request includes an identifier of a target application and a first location identifier of a terminal. The processing unit 1010 is configured to determine a first forwarding network element and a first processing network element based on the first location identifier, where the first forwarding network element is configured to: identify first service data from service data from the terminal based on a service flow identification model, and forward the first service data to the first processing network element, the first service data is service data of a target service in the target application, and the first processing network element is configured to process the first service data based on a function image of the target service. The transceiver unit 1020 is further configured to establish a transmission channel among the terminal, the first forwarding network element, and the first processing network element.

In a possible implementation, the processing unit 1010 is specifically configured to: determine, based on the first location identifier, whether a second forwarding network element that covers a location of the terminal exists, where the second forwarding network element has loaded the service flow identification model; and if such second forwarding network element exists, determine the second forwarding network element as the first forwarding network element; or if no such second forwarding network element exists, determine, based on the first location identifier, the first forwarding network element for loading the service flow identification model.

When the communication apparatus 1000 is configured to perform an operation performed by the second network element, the transceiver unit 1020 is configured to receive deployment request information from an application provider, where the deployment request information includes a service flow identification model and/or a function image of a target service. The processing unit 1010 is configured to determine, based on the deployment request information, first deployment area information of the service flow identification model and/or second deployment area information of the function image. The transceiver unit 1020 is further configured to send deployment information to a first network element, where the deployment information includes the first deployment area information and/or the second deployment area information.

In a possible implementation, the deployment request information further includes first deployment requirement information of the service flow identification model and/or second deployment requirement information of the function image, and the processing unit 1010 is specifically configured to determine the first deployment area information based on the first deployment requirement information; and/or determine the second deployment area information based on the second deployment requirement information.

The transceiver unit 1020 is further configured to perform another receiving or sending step or operation performed by the first forwarding network element, the first network element, or the second network element in the foregoing method embodiments. The processing unit 1010 may be further configured to perform another corresponding step or operation performed by the first forwarding network element, the first network element, or the second network element in the foregoing method embodiments other than receiving and sending. Details are not described herein again.

In embodiments of this application, module division is an example, and is merely a logical function division. In actual implementation, another division manner may be used.

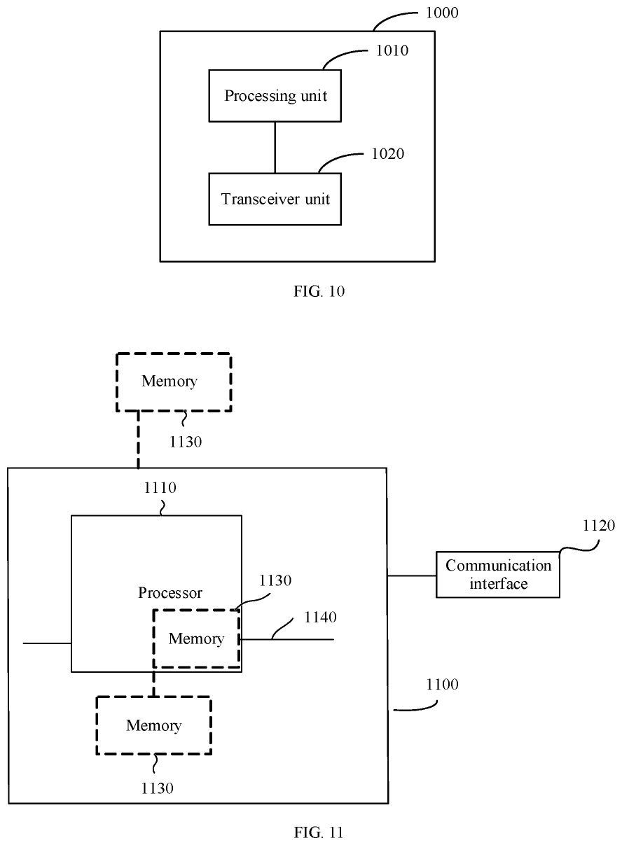

Refer to FIG. 11. An embodiment of this application further provides a communication apparatus 1100, configured to implement functions of the first forwarding network element, the first network element, and the second network element in the foregoing methods. The communication apparatus may be a network element, or may be an apparatus in a network element, or may be an apparatus that can be used together with a network element. The communication apparatus 1100 includes at least one processor 1110, and the communication apparatus 1100 may further include a communication interface 1120. In embodiments of this application, the communication interface may be a transceiver, a circuit, a bus, a module, or another type of communication interface, and is configured to communicate with another device through a transmission medium. For example, the communication interface 1120 is used by an apparatus in the communication apparatus 1100 to communicate with another device.

The processor 1110 may perform a function performed by the processing unit 1010 in the communication apparatus 1000. The communication interface 1120 may be configured to perform a function performed by the transceiver unit 1020 in the communication apparatus 1000.

When the communication apparatus 1100 is configured to perform an operation performed by the first forwarding network element, the communication interface 1120 is configured to receive a service flow identification model of a target service, and receive service data from a terminal. The processor 1110 is configured to identify, from the service data based on the service flow identification model, first service data of the target service and/or second service data of a non-target service. The communication interface 1120 is further configured to forward the first service data to the first processing network element, and forward the second service data to an anchor network element.

When the communication apparatus 1100 is configured to perform an operation performed by the first network element, the communication interface 1120 is configured to receive a service request, where the service request includes an identifier of a target application and a first location identifier of a terminal. The processor 1110 is configured to determine a first forwarding network element and a first processing network element based on the first location identifier, where the first forwarding network element is configured to: identify first service data from service data from the terminal based on a service flow identification model, and forward the first service data to the first processing network element, the first service data is service data of a target service in the target application, and the first processing network element is configured to process the first service data based on a function image of the target service. The communication interface 1120 is further configured to establish a transmission channel among the terminal, the first forwarding network element, and the first processing network element.

When the communication apparatus 1100 is configured to perform an operation performed by the second network element, the communication interface 1120 receives deployment request information from an application provider, where the deployment request information includes the service flow identification model and/or the function image of the target service. The processor 1110 is configured to determine, based on the deployment request information, first deployment area information of the service flow identification model and/or second deployment area information of the function image. The communication interface 1120 is further configured to send deployment information to the first network element, where the deployment information includes the first deployment area information and/or the second deployment area information.

The communication interface 1120 is further configured to perform another receiving or sending step or operation performed by the first forwarding network element, the first network element, or the second network element in the foregoing method embodiments. The processor 1110 may be further configured to perform another corresponding step or operation performed by the first forwarding network element, the first network element, or the second network element in the foregoing method embodiments other than receiving and sending. Details are not described herein again.

The communication apparatus 1100 may further include at least one memory 1130, configured to store program instructions and/or data. The memory 1130 is coupled to the processor 1110. Couplings in embodiments of this application are indirect couplings or communication connections between apparatuses, units, or modules, may be in an electrical form, a mechanical from, or another form for information exchange between the apparatuses, the units, or the modules. The processor 1110 may cooperate with the memory 1130. The processor 1110 may execute the computer program or instructions stored in the memory 1130. In a possible implementation, at least one of the at least one memory may be integrated with the processor. In another possible implementation, the memory 1130 is located outside the communication apparatus 1100.

In embodiments of this application, a specific connection medium between the communication interface 1120, the processor 1110, and the memory 1130 is not limited. In embodiments of this application, in FIG. 11, the memory 1130, the processor 1110, and the communication interface 1120 are connected through a bus 1140. The bus is represented by using a thick line in FIG. 11. A connection manner between other components is merely described as an example, and is not limited thereto. The bus may be classified into an address bus, a data bus, a control bus, and the like. For ease of representation, only one bold line is used to represent the bus in FIG. 11, but this does not mean that there is only one bus or only one type of bus.

In a possible implementation, the communication apparatus 1100 may be a chip system. In embodiments of this application, the chip system may include a chip, or may include a chip and another discrete component.

It should be understood that the processor mentioned in embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It may be understood that the memory mentioned in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM) , a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM).

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, function units in embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

1. A communication method, applied to a first forwarding network element, wherein the method comprises:
receiving a service flow identification model of a target service;
receiving service data from a terminal;
identifying, from the service data and based on the service flow identification model, at least one of first service data of the target service or second service data of a non-target service; and
at least one of:
forwarding the first service data to a first processing network element, wherein the first processing network element is configured to process the first service data based on a function image of the target service; or
forwarding the second service data to an anchor network element, wherein the anchor network element is configured to forward the second service data to an application server of the second service data, or is configured to process the second service data.

2. The method according to claim 1, wherein before receiving the service data from the terminal, the method further comprises:
receiving first transmission channel information, wherein the first transmission channel information indicates the first forwarding network element to forward the first service data to the first processing network element through a first transmission channel.

3. The method according to claim 2, wherein before receiving the service data from the terminal, the method further comprises:
sending second transmission channel information, wherein the second transmission channel information indicates the first processing network element to forward third service data of the target service to the first forwarding network element through a second transmission channel.

4. A communication method, applied to a first network element, wherein the method comprises:
receiving a service request, wherein the service request comprises an identifier of a target application and a first location identifier of a terminal;
determining a first forwarding network element and a first processing network element based on the first location identifier, wherein the first forwarding network element is configured to identify first service data from service data from the terminal based on a service flow identification model, and forward the first service data to the first processing network element, wherein the first service data is service data of a target service in the target application, and wherein the first processing network element is configured to process the first service data based on a function image of the target service; and
establishing a transmission channel among the terminal, the first forwarding network element, and the first processing network element.

5. The method according to claim 4, wherein determining the first forwarding network element based on the first location identifier comprises:
determining, based on the first location identifier, whether a second forwarding network element that covers a location of the terminal exists, wherein the second forwarding network element has loaded the service flow identification model; and
if the second forwarding network element exists, determining the second forwarding network element as the first forwarding network element; or
if the second forwarding network element does not exist, determining, based on the first location identifier, the first forwarding network element for loading the service flow identification model.

6. The method according to claim 5, wherein before receiving the service request, the method further comprises:
obtaining and sending the service flow identification model to the second forwarding network element.

7. The method according to claim 5, wherein after determining, based on the first location identifier, the first forwarding network element for loading the service flow identification model, the method further comprises:
obtaining and sending the service flow identification model to the first forwarding network element.

8. The method according to claim 6, wherein before sending the service flow identification model to the second forwarding network element, the method further comprises:
receiving deployment information from a second network element, wherein the deployment information comprises first deployment area information of the service flow identification model; and
determining the second forwarding network element based on the first deployment area information.

9. The method according to claim 6, wherein before sending the service flow identification model to the second forwarding network element, the method further comprises:
receiving deployment request information from an application provider, wherein the deployment request information comprises the service flow identification model;
determining first deployment area information of the service flow identification model; and
determining the second forwarding network element based on the first deployment area information.

10. The method according to claim 9, wherein the deployment request information further comprises first deployment requirement information of the service flow identification model; and
wherein determining the first deployment area information of the service flow identification model comprises:
determining the first deployment area information based on the first deployment requirement information.

11. The method according to claim 4, wherein determining the first processing network element based on the first location identifier comprises:
determining, based on the first location identifier, whether a second processing network element that covers a location of the terminal exists, wherein the second processing network element has loaded the function image; and
if such second processing network element exists, determining the second processing network element as the first processing network element; or
if no such second processing network element exists, determining, based on the first location identifier, the first processing network element for loading the function image.

12. The method according to claim 11, wherein before receiving the service request, the method further comprises:
obtaining and sending the function image to the second processing network element.

13. The method according to claim 11, wherein after determining, based on the first location identifier, the first processing network element for loading the function image, the method further comprises:
obtaining and sending the function image to the first processing network element.

14. The method according to claim 12, wherein before sending the function image to the second processing network element, the method further comprises:
receiving deployment information from the second network element, wherein the deployment information comprises second deployment area information of the function image; and
determining the second processing network element based on the second deployment area information.

15. The method according to claim 12, wherein before determining the second processing network element for the function image, the method further comprises:
receiving deployment request information from an application provider, wherein the deployment request information comprises the function image;
determining second deployment area information of the function image; and
determining the second processing network element based on the second deployment area information.

16. The method according to claim 15, wherein the deployment request information further comprises second deployment requirement information of the function image; and
wherein determining the second deployment area information of the function image comprises:
determining the second deployment area information based on the second deployment requirement information.

17. The method according to claim 9, wherein receiving the deployment request information from the application provider comprises:
receiving the deployment request information that has been verified from a third network element, wherein the third network element is configured to verify information from the application provider.

18. The method according to claim 4, wherein before determining the first forwarding network element and the first processing network element based on the first location identifier, the method further comprises:
obtaining third deployment requirement information of the target service, wherein the third deployment requirement information comprises at least one of service quality information or delay requirement information of the target service; and
wherein determining the first forwarding network element and the first processing network element based on the first location identifier comprises:
determining the first forwarding network element and the first processing network element based on the third deployment requirement information and the first location identifier.

19. The method according to claim 4, wherein a distance between the first processing network element and the terminal is greater than a distance between the first forwarding network element and the terminal.

20. The method according to claim 4, wherein the first forwarding network element and the first processing network element are a same network element.

21. The method according to claim 4, wherein there are a plurality of first forwarding network elements.

22. A communication method, applied to a second network element, wherein the method comprises:
receiving deployment request information from an application provider, wherein the deployment request information comprises at least one of a service flow identification model or a function image of a target service;
determining, based on the deployment request information, at least one of first deployment area information of the service flow identification model or second deployment area information of the function image; and
sending deployment information to a first network element, wherein the deployment information comprises at least one of the first deployment area information or the second deployment area information.

23. The method according to claim 22, wherein the deployment request information further comprises at least one of first deployment requirement information of the service flow identification model or second deployment requirement information of the function image; and
wherein determining, based on the deployment request information, at least one of the first deployment area information of the service flow identification model or the second deployment area information of the function image comprises at least one of:
determining the first deployment area information based on the first deployment requirement information; or
determining the second deployment area information based on the second deployment requirement information.

24. The method according to claim 22, wherein receiving the deployment request information from the application provider comprises:
receiving the deployment request information that has been verified from a third network element, wherein the third network element is configured to verify information from the application provider.
